(19) United States
(12) Patent Application Publication
(10) Pub. No.: US 2024/0413853 A1
(43) Pub. Date: Dec. 12, 2024

(54) Wall Switch

(71) Applicant: Scot Rex SATRE, Brentwood, CA (US)

(72) Inventor: Scot Rex SATRE, Brentwood, CA (US)

(21) Appl. No.: 18/330,535

(22) Filed: Jun. 7, 2023

(51) Int. Cl. H04B 5/00; G06K 7/10; G06K 19/07

(52) U.S. Cl. CPC H04B 5/77; G06K 7/10297; G06K 19/0723

(57) ABSTRACT

The invention is a Wall Switch with NFC Interface for Transmitting Energy usage information to an NFC Reader such as a Smartphone. When an ordinary wall switch is in the ON position it is difficult for the user to get an energy usage measurement of the device or appliance that's under control of the wall switch. The invention allows the Wall Switch user to easily obtain an energy usage measurement and may also allow the user to easily obtain the energy usage cost.

### BACKGROUND OF THE INVENTION

The field of the invention relates to energy usage when flipping a wall switch.

A wall switch is used to control a device such as a light bulb. However, obtaining an energy usage measurement of the device is difficult.

Accordingly, there's a need in the art for an improved Wall Switch.

### SUMMARY OF THE INVENTION

This invention relates to a wall switch. More specifically, the invention relates to a wall switch and how much energy is used when the wall switch is in the ON position. This invention allows the wall switch user to easily obtain a measurement of energy usage of a device that's controlled by the wall switch.

### BRIEF DESCRIPTION OF DRAWINGS

FIG. 1. Shows a smartphone reading an NFC tag via the NFC function of the phone.

FIG. 2. An example of a text message on a smartphone after reading data from an NFC Tag.

FIG. 3. An example of a dialog box on a smartphone that displays the option to visit a web address after reading data from an NFC Tag.

FIG. 4. Shows a smartphone reading information from a wall switch via the NFC function of the phone.

FIG. 5. An example of a 1-line text message on a smartphone after reading the Wall Switch.

FIG. 6. An example of a 2-line text message on a smartphone after reading the Wall Switch.

FIG. 7. An example dialog box on a smartphone that displays the option to visit a web address after reading the wall switch.

### DETAILED DESCRIPTION OF THE INVENTION

NFC (Near Field Communication) is becoming a more widely used interface. Many people have never heard the acronym, NFC. On the other hand, almost everyone has heard about the payment systems, Android Pay and Apple Pay, both of which make use of the NFC interface found on every smartphone and many tablets.

The NFC interface is short range and works over distances from 0-4 inches. The NFC interface uses an electromagnetic RF field with a frequency of 13.56 MHz

The short range makes the NFC interface well suited for secure contactless payment such as Android Pay and Apple Pay. Also, many credit cards also have the ability to make contactless payments that use the NFC interface. These credit cards contain a very small integrated circuit (IC) and an antenna. These contactless payment methods use a data transfer standard that was established by “U.S. Payments Forum” and uses encryption techniques. This standard is complex and not needed for the invention described below.

The invention described below makes use of a data transfer standard that was established by the NFC Forum. This standard allows simple messages to be transferred via the NFC interface. All smartphones are capable of following one or more of the standards established by the NFC Forum.

An example of a device that follows the NFC Forum standard is an NFC Tag. An NFC Tag is usually a small piece of thin plastic that contains an IC and an Antenna, much like a contactless credit card. The IC is very small, about the size of a grain of sand.

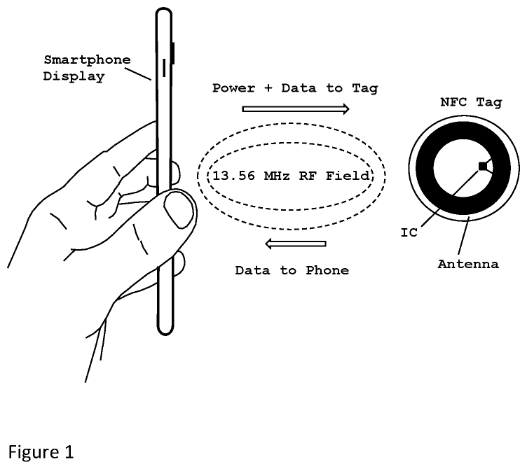

FIG. 1 illustrates a smartphone reading information from a NFC Tag. On a smartphone, the NFC interface is on the backside of the phone opposite the display side. When the backside of the smartphone is close to the NFC Tag, the smartphone will automatically establish a 13.56 MHz RF field and begin to activate and communicate with the NFC Tag. The IC in the NFC Tag will use the Antenna to get its power and its data/commands from the RF field. The NFC Tag will send data/response back to the phone via the RF field.

The smartphone shown in FIG. 1 is commonly referred to as the NFC Reader because it's the device that supplies the 13.56 MHz RF field and is the device that sends commands to the NFC Tag. The NFC Tag behaves as a “slave” device.

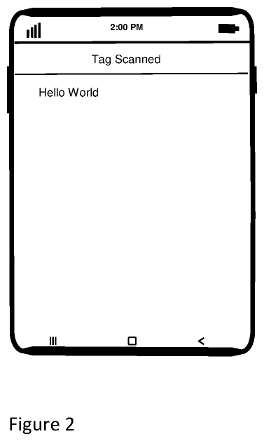

One of the standard data formats established by the NFC Forum that may be useful for the invention described below will allow the NFC Tag to send back a text message. In this scenario, when the backside of a smartphone is close to the NFC Tag, the phone will receive the text message, give an audio prompt and automatically display the text message on the phone display. FIG. 2 illustrates what the smartphone display might look like when the NFC Tag is programmed to send back the text message “Hello World”.

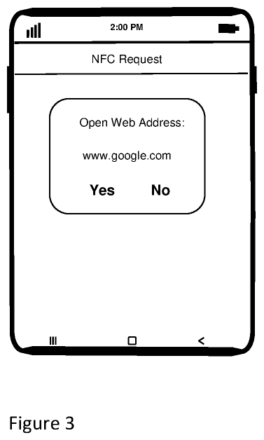

Another standard data format established by the NFC Forum that may be useful for the invention described below will allow the NFC Tag to send back a website address. In this scenario, when the backside of a smartphone is close to the NFC Tag, the phone will receive the message, give an audio prompt and automatically display the website address on the phone display along with the option to proceed or decline. FIG. 3 illustrates what the smartphone display might look like when the NFC Tag is programmed to send back the website address for Google. Also shown are “Yes” and “No” buttons for the option to proceed or decline.

It should be noted that, a smartphone with the proper settings will display the NFC messages shown in FIG. 2 and FIG. 3 without the need to install application software.

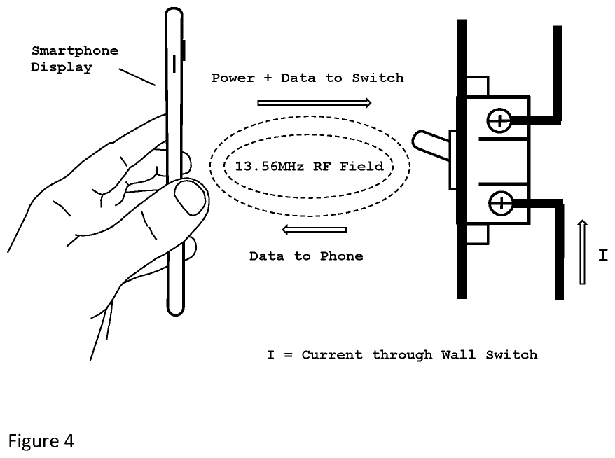

FIG. 4 illustrates the invention. FIG. 4 is the same as FIG. 1 except that the NFC Tag is replaced with a Wall Switch that contains an NFC interface much like a tag. The Wall Switch contains a means for measuring its current and thus can send the measurement back to the phone as part of its data.

It should be noted that the Wall Switch is physically much bigger than an NFC Tag and therefore the implementation of the invention can use either a custom integrated circuit or off-the-shelf components.

Much like a tag, when the backside of the smartphone is close to the Wall Switch, the smartphone will automatically establish a 13.56 MHz RF field and begin to activate and communicate with the Wall Switch. The circuitry in the Wall Switch will use an Antenna to get its power and its data/commands from the RF field. The Wall Switch will send data/response back to the phone via the RF field. Included in the data will be a measurement of the current as an indicator of how much energy is being used.

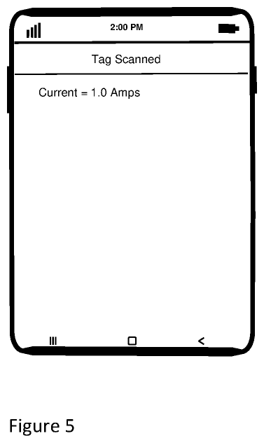

FIG. 5 illustrates an example of what the smartphone display might look like when the Wall Switch is designed to send back a current measurement of 1.0 Amps in the form of a text message.

Most people may not be familiar with current as a measurement of energy usage. The units of “Wattage” may be more familiar. In this case, the wattage can be easily calculated as the product of Current times Voltage. If we assume the standard house voltage of 120V, the wattage will be 120 Watts when the current measured is 1.0 Amps.

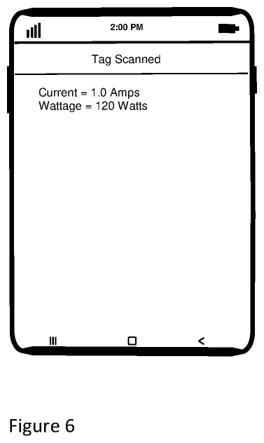

FIG. 6 illustrates an example of what the smartphone display might look like when the Wall Switch is designed to send back a current measurement of 1.0 Amps and the calculated wattage in the form of a 2-line text message.

In order to determine an accurate cost of energy usage, the smartphone user will need to know the cost of electricity for their particular region of the country. The time of day and how long the switch remains in the ON position will also be a factor. These factors can make an energy usage cost difficult to calculate. To resolve this difficulty, the Wall Switch can be designed to send back a website address that includes the wattage as parameter. If a user chooses to go to the website the energy cost can be quickly calculated using the wattage that was included as a parameter.

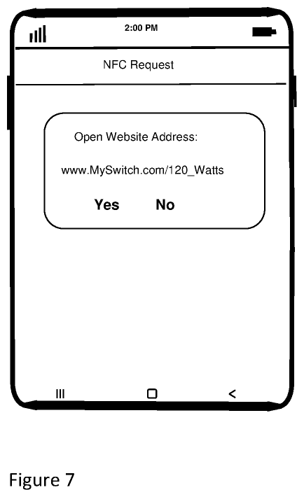

FIG. 7 illustrates an example of what the smartphone display might look like when the Wall Switch is designed to send back a website address and the calculated wattage for a current measurement of 1.0 Amps. In this example, the parameter sent to the website is 120_Watts. The website will use this parameter to give the Wall Switch user cost information.

1. Wall Switch with NFC interface for transmitting energy usage information to an NFC device such as a Smartphone.
